(19) United States
(12) Patent Application Publication
(10) Pub. No.: US 2010/0325333 A1
(43) Pub. Date: Dec. 23, 2010

(54) Method Allowing Processor with Fewer Pins to Use SDRAM

(75) Inventors: Paul Kimelman, Alamo, CA (US); Ian Harold Field, Olympia, WA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/579,047

(22) Filed: Oct. 14, 2009

Related U.S. Application Data
(60) Provisional application No. 61/105,256, filed on Oct. 14, 2008.

(51) Int. Cl. G06F 13/14

(52) U.S. Cl. 710/306

(57) ABSTRACT

The invention is an apparatus and method to allow a microcontroller unit with fewer pins to use SDRAM. This invention uses the SDRAM burst mode in a favorable way. On an initial cycle of the burst access the microcontroller supplies an address one less than the actual initial address on a multiplexed address/data bus connected to both the address bus and the data bus of the SDRAM. DQM signals from the microcontroller to the SDRAM suppress all data writes. On the second and subsequent cycles of the burst assess, the microcontroller supplies the next data word to be written on the multiplexed address/data bus together with DQM signals permitting data writing. This technique prevents collisions of address and data on the microcontroller multiplexed address/data bus.

### CLAIM OF PRIORITY

This application claims priority under 35U.S.C. 119(e)(1) to U.S. Provisional Application No. 61/105,256 filed Oct. 14, 2008.

### TECHNICAL FIELD OF THE INVENTION

The technical field of this invention is processor technology in communicating with external devices and more specifically microcontrollers communicating with SDRAM.

### BACKGROUND OF THE INVENTION

Existing microprocessors access synchronous dynamic random access memories (SDRAMs) using the full set of pins. Many will connect a set of SDRAMs in parallel to get wider data widths (such as used by dual in line memory modules (DIMMs)), but none are concerned with fewer pins. The main focus of most microprocessors is maximizing performance, since the SDRAM is the memory used by the processor.

Microcontroller units (MCUs) traditionally try to have all memory in the chip and try to minimize number of pins. MCUs with external memory normally pin limit by use of narrower data widths, narrower address widths, both or multiplexing address and data. Narrow data widths require more data accesses. Narrower address widths limit the amount of memory addressable. Multiplexing of address and data has been used for older style SRAMs and Flash devices because the address versus data read/write are separate operations controlled by strobes (request pins) at the expense of speed. In other cases, multiplexing is used with an external device which maps fewer pins to the larger number of pins needed but still at the expense of speed.

SDRAMs are not amendable to the traditional multiplexing because they use a different operational model. The address versus data operation is controlled by commands and is clocked. Separate strobed pins are not used.

### SUMMARY OF THE INVENTION

The invention is an apparatus and method to allow processor use of SDRAM with fewer pins. The invention favorably uses a burst mode. In this invention the address before the actual initial write address is used in the first cycle of the burst mode having a burst size of two or more. In addition, in the first cycle all data writes are suppressed via data mask (DQM) signals. During second and subsequent cycles at least some data writes are permitted by DQM signals. Bursts larger than two allow normal use of burst writes in subsequent cycles because the address is supplied only with an initiating write command.

### BRIEF DESCRIPTION OF THE DRAWINGS

These and other aspects of this invention are illustrated in the drawings, in which:

FIG. 1 is a block diagram of the apparatus of the invention; and

FIG. 2 is a flow chart of the method of the invention.

### DETAILED DESCRIPTION OF PREFERRED EMBODIMENTS

This invention allows an MCU to use SDRAM with fewer pins. This disclosure includes numerous specific details to provide a thorough understanding of the invention. One skilled in the art would appreciate that one may practice the invention without some or all of these specific details. This disclosure does not describe some well known items in detail in order not to obscure the invention.

The standard approach when using SDRAM memory with a microcontroller unit devotes a full set of pins to cover address, command, data and control. This large number of pins requires larger packaging for the MCU and far more power to control and drive all of the pins. This invention reduces the number of pins without specialized hardware external to the MCU. This reduction in the number of pins is achieved by multiplexing the address output of the MCU with the data input/output of the MCU.

This invention uses logic in the MCU to access the SDRAM with 14 to 16 fewer pins. The address and data pins are overlapped or wire ORed. Special operational logic ensures there are no conflicts.

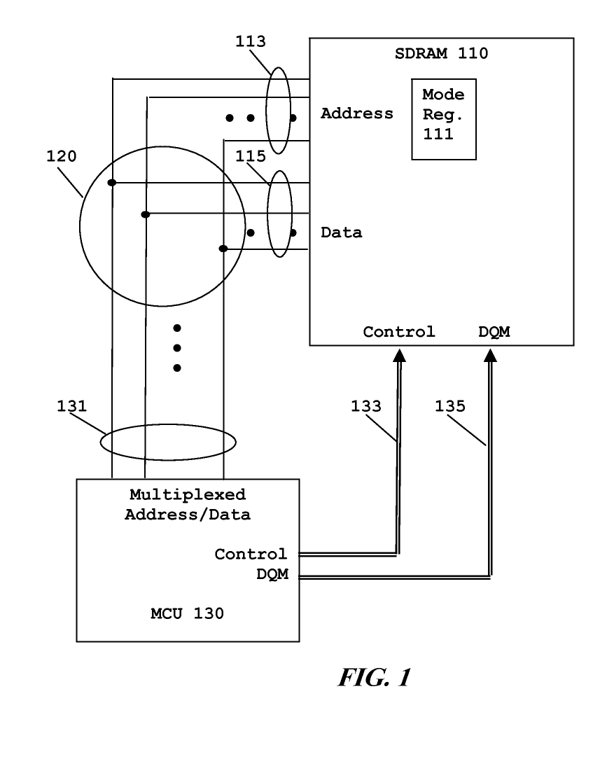

FIG. 1 is a block diagram of the apparatus of the invention. SDRAM 110 is connected to microcontroller unit (MCU) 130. SDRAM 110 and MCU 130 are separate integrated circuits. MCU 130 drives a multiplexed address/data bus 131. This multiplexed address/data bus 131 is connected to both address bus 113 and data bus 115 of SDRAM 110 via wired OR 120. MCU 130 includes separate busses driving SDRAM 110. Bus 133 supplies control signals to SDRAM 110 to control its operating mode. Bus 135 supplies one or more data write masking signals DQM to SDRAM 110. SDRAM includes mode register 111 used as explained below.

This invention advantageously uses a commonly supported burst mode in SDRAMs. In a burst read, MCU 130 supplies an initial memory address. The SDRAM returns data starting at this initial address during a following clock cycle. The SRRAM returns data from the next following addresses in subsequent clock cycles up to the burst length.

SDRAM read operations naturally support the wired OR 120 illustrated in FIG. 1. The SDRAM must receive the address two or three clock cycles before the data returns. Thus the address supplied from MCU 130 to SDRAM 110 via bus 131, wired OR 120 and bus 113 does not interfere with data returned from SDRAM 110 to MCU 130 via bus 115, wired OR 120 and bus 131. This invention does not enable high speed pipelined operation where a next read address is supplied to SDRAM 110 while the current read operation completes. The goal of this invention is not the highest possible memory access speed. Read speed is more optimized using the burst mode of the SDRAM. This invention does not prevent or change the SDRAM burst read mode except for not permitting pipelined operations.

This invention also permits write operations. SDRAM writes typically require that the initial address and the data of the write operation to be stored at the initial address be present on respective address and data pins at the same time during the same memory clock cycle. This would normally prevent using the wired OR of this invention. This invention favorably uses write masking in the burst mode. This invention presents the address one less than the initial write address to the SDRAM with a burst size of two or more. The SDRAM burst write operation would ordinarily store the data on the data bus during this initial memory cycle into the supplied memory address. With wire OR 120, this data would be the address one less than the initial write address. This invention suppresses the first write in this burst mode via DQM data masking signals. Thus this first write has no effect. DQM mask signals are normally used to allow independent writes of lower or upper byte in a by-16 SDRAM or any of 4 bytes in a by-32 SDRAM rather than writing the whole data word. This invention uses such DQM signals to prevent any write during the first cycle of the burst write access by masking all bytes. This invention thus uses these DQM signals to separate the address from the data. In this invention the first write cycle of the burst mode writes the address. The second write cycle in the burst mode writes the initial data. The DQM mask signals permit a normal write operation during the second write cycle. Burst accesses larger than two allow normal use of burst writes, where the address is supplied only with the initiating write command. Thus MCU 130 supplies the write data for sequential addresses in sequential memory clock cycles.

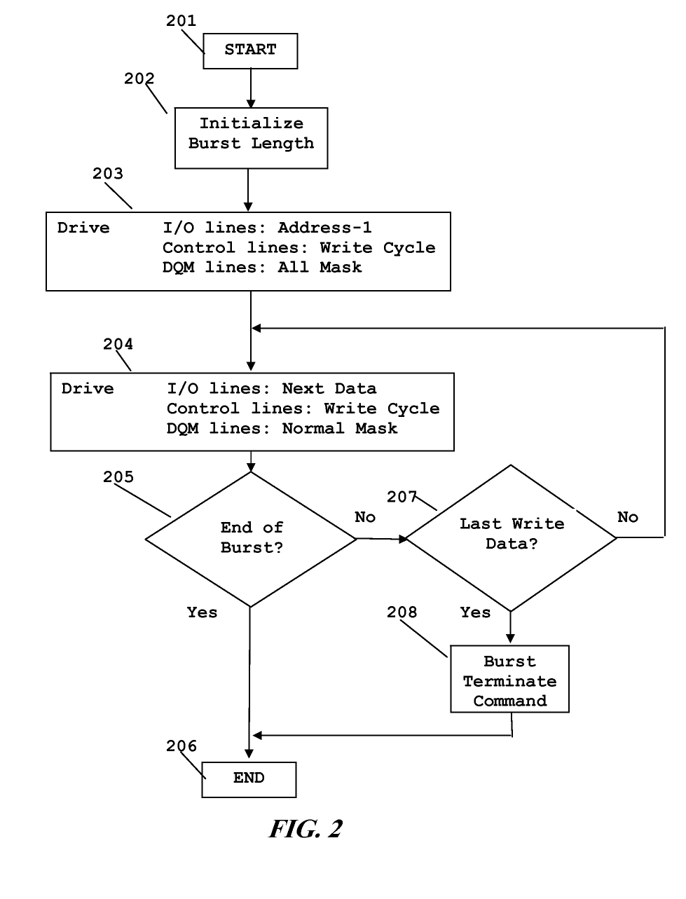

FIG. 2 illustrates a flow chart of the method of this invention. MCU 130 is programmed to perform data writes in this manner. A memory write cycle begins with start block 201. Note that memory read cycles are unchanged in this invention. The method initializes the burst length for the upcoming burst write. In the typical SDRAM a code corresponding to the burst length is stored in mode register 111. A typical SDRAM employs a special load mode register cycle signaled by the control inputs to the SDRAM. In the typical SDRAM address bus 113 specifies the data to be stored in mode register 111 during this load mode register cycle. The burst length is selected in relationship to the amount of data to be stored. The burst length must be one more than the data words to be stored. The minimum burst length using this invention is two. The typical allowed burst lengths in an SDRAM are integral powers of two, thus 1, 2, 4, 8, 16, etc. If the number of data words does not equal one less than an allowable burst length, MCU 130 can request a longer burst length and issue a burst terminate command following the last data write to memory. In the typical SDRAM a burst terminate command ends a burst access regardless of the amount of data transferred. Alternately, two or more burst accesses can be used.

Block 203 notes the actions of MCU 130 during a first memory cycle in the burst access. MCU 130 supplies an address on multiplexed address/data bus 131. This address is one less than the actual initial address of the upcoming write cycle. MCU 130 supplies signals on control bus 133 to trigger a burst access write. Finally, MCU 130 supplies signals on the one or more lines of DQM bus 135 to prevent any memory write. This is noted in block 203 as “All Mask.” The result of this first cycle is to start an SDRAM burst access with the next cycle at the initial address of the desired memory write.

Block 204 notes the actions of MCU 130 during the second and any subsequent memory cycles in the burst access. MCU 130 supplies the next data on multiplexed address/data bus 131. In the case of the second cycle in the burst access, this next data is the data to be stored in the first address of the write operation. MCU 130 supplies signals on control bus 133 to continue the burst access write. MCU 130 supplies signals on the one or more lines of DQM bus 135 to permit normal memory write. This is noted in block 204 as “Normal Mask.” Depending upon the particular memory write operation the signals on DQM bus 135 may block some byte memory writes. However, at least one byte write is allowed during the second cycle of the burst access.

The method determines if the last cycle was the end of the burst access in test block 205. If the last cycle was the end of the burst (Yes at test block 205), then the method ends at end block 206.

If the last cycle was not the end of the burst (No at test block 205), then the method determines whether the previous cycle supplied the last data in the data write in test block 207. If the last cycle stored the last data (Yes at test block 207), then MCU 130 issues a burst terminate command (block 208) via command bus 133. Thereafter the method ends at end block 206.

If the last cycle did not store the last data (No at test block 207), then MCU 130 returns to block 204. MCU 130 supplies the next data on multiplexed address/data bus 131, supplies signals on control bus 133 to continue the burst access write and supplies signals on the one or more lines of DQM bus 135 to permit normal memory write.

The invention is an apparatus and method allowing an MCU to use an SDRAM with fewer MCU pins. The invention favorably uses the SDRAM burst mode. In the invention the MCU supplies the address before the actual initial write address to the SDRAM in a burst mode with a burst size of two or more. In the invention, the first burst mode write cycle writes the address and blocks the all data writes via DQM masking. For second and subsequent cycles, the MCU supplies the write data and unmasks one or more DQM pins.

What is claimed is:

1. A microcontroller system comprising:
an SDRAM integrated circuit having an address bus, a data bus, a control bus input and at least one DQM input;
a microcontroller unit integrated circuit having a multiplexed address/data bus, a control bus output connected to said control bus input of said SDRAM and at least one DQM output connected to said DMQ input of said SDRAM; and
a wired OR connecting each of a plurality of lines of said multiplexed address/data bus of said microcontroller unit to both a corresponding line of said address bus of said SDRAM and a corresponding line of said data bus of said SDRAM.

2. A method of connecting and operating a combination of a microcontroller unit and an SDRAM, comprising the steps of:
connecting a multiplexed address/data bus of a microcontroller unit to an address bus and a separate data bus of an SDRAM wherein each of a plurality of lines of the multiplexed address/data bus of the microcontroller unit is connected to both a corresponding line of the address bus of the SDRAM and a corresponding line of the data bus of the SDRAM;
connecting a control bus output of the microcontroller unit to a control bus input of the SDRAM;
connecting at least one DQM output of the microcontroller to a DQM input of the SDRAM;
simultaneously for an initial memory cycle
supplying an address one less than an initial write address from the multiplexed address/data bus of the microcontroller unit to the address bus and the separate data bus of the SDRAM,
supplying control signals from the microcontroller unit to the SDRAM to start a burst access, and
supplying DQM signals from the microcontroller unit to the SDRAM to block all data writing; and
simultaneously for at least one subsequent memory cycle
supplying next write data word from the multiplexed address/data bus of the microcontroller unit to the address bus and the separate data bus of the SDRAM,
supplying control signals from the microcontroller unit to the SDRAM to continue the burst access, and
supplying DQM signals from the microcontroller unit to the SDRAM to permit data writing.

3. The method of claim 2, further comprising the steps of:
the microcontroller unit setting a burst length of two or greater in the SDRAM.

4. The method of claim 2, further comprising the steps of:
the microcontroller unit supplying a burst terminate command to the SDRAM upon writing a last data word before expiration of the burst length.

5. A microcontroller unit adapted for connection to and operation of an SDRAM, comprising:
a multiplexed address/data bus;
a control bus output;
at least one DQM output;
the microcontroller unit programmed to
simultaneously for an initial memory cycle
supply an address one less than an initial write address from the multiplexed address/data bus of the microcontroller unit,
supply control signals from the control bus output of the microcontroller unit to start an SDRAM burst access, and
supply DQM signals from the at least one DQM output of the microcontroller unit to block all data writing in an SDRAM; and
simultaneously for at least one subsequent memory cycle
supply a next write data word from the multiplexed address/data bus of the microcontroller unit,
supply control signals from the control bus output of the microcontroller unit to continue the SDRAM burst access, and
supply DQM signals from the at least one DQM output of the microcontroller unit to permit data writing in an SDRAM.

6. The microcontroller unit of claim 5, wherein:
the microcontroller unit further programmed to set a burst length of two or greater in the SDRAM via signals on the multiplexed address/data bus and the control bus output.

7. The microcontroller unit of claim 5, wherein:
the microcontroller unit further programmed to supply a burst terminate command via signals on the control bus output upon writing a last data word before expiration of the burst length.
